(19) United States
(12) Patent Application Publication
(10) Pub. No.: US 2010/0243180 A1
(43) Pub. Date: Sep. 30, 2010

(54) PANEL ASSEMBLIES HAVING CONTROLLABLE SURFACE PROPERTIES

(76) Inventors: CHARLES HOBERMAN, New York, NY (US); Matthew Davis, Newtown, PA (US); Zygmunt Joseph Drozdowski, Brooklyn, NY (US); David Wight, Montclair, NJ (US)

Correspondence Address: GOTTLIEB RACKMAN & REISMAN PC, 270 MADISON AVENUE, 8TH FLOOR, NEW YORK, NY, 10016-0601, US

(21) Appl. No.: 12/729,598

(22) Filed: Mar. 23, 2010

Related U.S. Application Data
(60) Provisional application No. 61/162,901, filed on Mar. 24, 2009.

(51) Int. Cl. E06B 3/32

(52) U.S. Cl. 160/218

(57) ABSTRACT

An assembly comprised of at least one fixed panel and at least two moveable panels is provided. The moveable panels are capable of being controllably shifted relative both to each other and to the fixed panel such that first and second aligned and non-aligned positions can be achieved. The assembly is further comprised of two or more drive links which are, in turn, comprised of a center pivot which engages with the fixed panel and two or more outer pivots which engage with the movable panels.

This invention relates to a unique type of panel assembly. The application claims priority benefit of U.S. Provisional Application No. 61/162,901, filed Mar. 24, 2009.

### BACKGROUND OF THE INVENTION

The façade of a building plays a central role in a building's environmental performance, influencing energy usage by determining how light, heat and air are exchanged with its surroundings. As one example, the interlocking systems that comprise curtain walls for high-rise buildings: structural, glazing, insulation, ventilation and shading, all play a role in managing the energy flows between interior and exterior.

One key strategy to achieve sustainable performance is for buildings to actively adapt and respond to changing climatic conditions. This strategy may be applied to facades in different ways. For example, an adaptive façade may have operable elements such as shades that extend and retract automatically. Those devices can respond to environmental data (i.e. temperature, light intensity and wind flow) gathered from sensors, and, utilizing computational intelligence, the building can optimize its environmental configuration for different environmental conditions.

This concept of a responsive facade has been termed “intelligent skin” indicating the analogy with natural systems.

A significant portion of the façade is comprised of windows—or more generally, glazed areas. Static methods are often used to set the light transmissivity of glass. Ceramic fritting is widely utilized where a graphic pattern is applied to glass in order to block some light transmission, yet still allowing sufficient transparency for viewing. However, standard ceramic fritting is static and does not respond to changing conditions.

By integrating responsive controls with fritted glass surfaces, improved light control and decreased energy usage can be achieved.

An adaptive window could, for example, allow solar gain during cold weather, yet block the sun when it is warm. Natural light within the building can be maintained at desirable levels. Controllable transparency can also be used to allow visual contact when needed, yet provide privacy under other circumstances.

Beyond transparency control, a physical surface that can adjust its permeability, thereby controlling the passage of air, moisture or heat, provides additional benefits. Utilizing an exterior layer having controllable permeability, energy from the environment may be accepted or blocked as needed.

Currently, such adaptive control within the facade is achieved with standard products such as blinds, shades or curtains. Beyond traditional devices, a new generation of adaptive glass technology is available such as ‘switchable’ and ‘electrochromic’ glass. However, these technologies have not received wide acceptance to date.

The invention disclosed herein provides new methods to provide surfaces having controllable properties. Such properties include transparency, permeability and acoustic performance. Surfaces that are formulated according to the disclosed invention may then be integrated into building façades as an ‘adaptive layer’ providing enhanced environmental performance.

### SUMMARY OF THE INVENTION

An assembly comprised of at least one fixed panel and at least two moveable panels is provided. The moveable panels are capable of being controllably shifted relative both to each other and to the fixed panel such that first and second aligned and non-aligned positions can be achieved.

The assembly is further comprised of two or more drive links which are, in turn, comprised of a center pivot which engages with the fixed panel and two or more outer pivots which engage with the movable panels.

Also disclosed are fixed and movable panels that can be constructed from perforated sheets, or from transparent sheets which can have an applied graphic pattern. When the panel assembly is in its first position, these perforations, or graphic patterns, are aligned from sheet to sheet, providing a surface that is largely transparent and/or permeable. When the panel assembly is in its second position, the perforations or graphic patterns belonging to the different panels are not aligned, thereby providing a surface that is largely opaque and/or impermeable.

Accordingly, it is an object of the invention to provide surfaces having controllable properties.

Another object of the invention is to provide an improved surface in which the transparency, permeability and acoustic performance can be selectively controlled.

Still, other objects and advantages of the invention will, in part, be obvious and will, in part, be apparent from the following description.

### BRIEF DESCRIPTION OF THE DRAWINGS

For a fuller understanding of the invention, reference is made to the following drawings in which:

FIG. 1 shows an exploded view of a drive link of the invention;

FIG. 2 shows a perspective view of the inventive drive link;

FIG. 3 shows a perspective view of a second drive link of the invention;

FIG. 4 shows an exploded view of a first panel assembly of the invention;

FIGS. 5-8 shows perspective views of the inventive panel assembly of FIG. 4 as it is transformed from an initial position to a final position;

FIG. 9 shows an exploded view of a third drive link of the invention;

FIG. 10 shows a perspective view of the inventive drive link of FIG. 9;

FIGS. 11-13 show successively a plan and two sectional views of the drive link of FIG. 9;

FIG. 14 shows a fourth drive link of the invention having a handle element;

FIGS. 15-18 show plan views of four panels of the invention;

FIGS. 19-20 show perspective views of drive links of the invention in accordance with FIGS. 9 and 10;

FIG. 21 shows an exploded view of a second panel assembly of the invention;

FIGS. 22-24 show plan views of the panel assembly of FIG. 21 as it is transformed from an initial position to a final position;

FIGS. 25-26 show a sectional view and a detail plan view respectively of the panel assembly of FIG. 21;

FIGS. 27-29 shows perspective views of the panel assembly of FIG. 21 as it is transformed from an initial position to a final position;

FIGS. 30-33 show plan views of four other panels of the invention, each with circular perforations;

FIG. 34 shows an exploded view of a third panel assembly of the invention;

FIGS. 35-37 shows perspective views of the panel assembly of FIG. 34 as it is transformed from an initial, aligned position to a final non-aligned position.

FIGS. 38-40 shows cutaway views of the panel assembly of FIG. 34 as it is transformed from an initial, aligned position to a final non-aligned position.

FIGS. 41-43 shows plan views of the panel assembly of FIG. 34 as it is transformed from an initial, aligned position to a final non-aligned position;

FIGS. 44-47 show plan views of four additional panels of the invention which are transparent and have an applied graphic pattern;

FIG. 48 shows an exploded view of a fourth panel assembly of the invention;

FIGS. 49-51 shows perspective views of the panel assembly of FIG. 48 as it is transformed from an initial, aligned position to a final non-aligned position;

FIGS. 52-54 shows cutaway views of the panel assembly of FIG. 48 as it is transformed from an initial, aligned position to a final non-aligned position;

FIGS. 55-57 shows plan views of the panel assembly of FIG. 48 as it is transformed from an initial, aligned position to a final non-aligned position;

FIGS. 58-59 show exploded and perspective views, respectively, of a fourth drive link of the invention;

FIG. 60 shows an exploded view of a fifth panel assembly of the invention;

FIG. 61 shows a sectional view of the panel assembly of FIG. 60;

FIGS. 62-65 show detailed perspective views of the panel assembly of FIG. 60 as it is transformed from an initial, aligned position to a final non-aligned position; and

FIGS. 66-69 show plan views of the panel assembly of FIG. 60 as it is transformed from an initial, aligned position to a final non-aligned position.

### DETAILED DESCRIPTION OF THE PREFERRED EMBODIMENT

FIG. 1 shows an exploded view of drive link 10 which is comprised of sub-links 14 and 16. Also shown are outer pivot pins 19 and 17, as well as center pivot pin 11a which is co-linear with center pivot pin 11b.

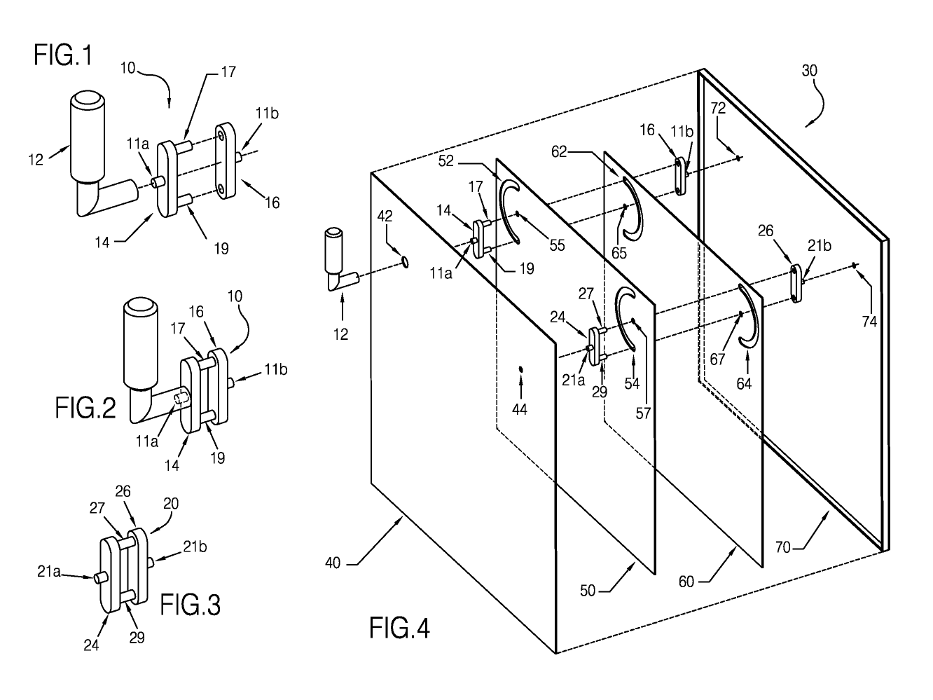

FIG. 2 shows a perspective view of drive link 10 in assembled form. It may be seen that outer pivot pins 19 and 17 span between sub-links 14 and 16. Also shown is center pivot pin 11a which is co-linear, yet discontinuous, with pivot pin 11b. Center pivot pin 11a is connected to a handle element 12.

FIG. 3 shows drive link 20 which is comprised of sub-links 24 and 26 which, in turn, are connected by outer pivot pins 29 and 27. Sub-link 24 and sub-link 26 lie in different planes relative to one another. Outer pivots 29 and 27 span the depth of link 20. Also shown is center pivot pin 21a and center pivot pin 21b which are co-linear yet discontinuous.

FIG. 4 shows an exploded view of panel assembly 30 which is comprised of two fixed panels 40 and 70 and two movable panels 50 and 60.

Front panel 40 has two pivot holes 42 and 44. Back panel 70 has two pivot holes 72 and 74 which are respectively aligned with and correspond to pivot holes 42 and 44. Center pivot pins 11a and 21a belonging to drive links 10 and 20 respectively are aligned with pivot holes 42,44 respectively; center pivot pins 11b and 21b belonging to drive links 10 and 20 respectively are aligned with pivot holes 72,74 respectively.

Panel 50 has two clearance slots 52 and 54 providing clearance for outer pivot pins 19 and 29 respectively. Panel 60 has two clearance slots 62 and 64 providing clearance for outer pivot pins 17 and 27 respectively.

Outer pivot pin 17 of drive link 10 is aligned with pivot hole 55 on panel 50. Outer pivot pin 19 of drive link 10 is aligned with pivot hole 65 on panel 60.

Outer pivot pin 27 of drive link 20 is aligned with pivot hole 57 on panel 50. Outer pivot pin 29 of drive link 20 is aligned with pivot hole 67 on panel 60.

FIG. 5 shows panel assembly 30 in an initial position where movable panel 50 is in an upper location and movable panel 60 is in a lower location. Links 10 and 20 are pivotally connected to front panel 40 by center pivot pins 11a and 21a respectively.

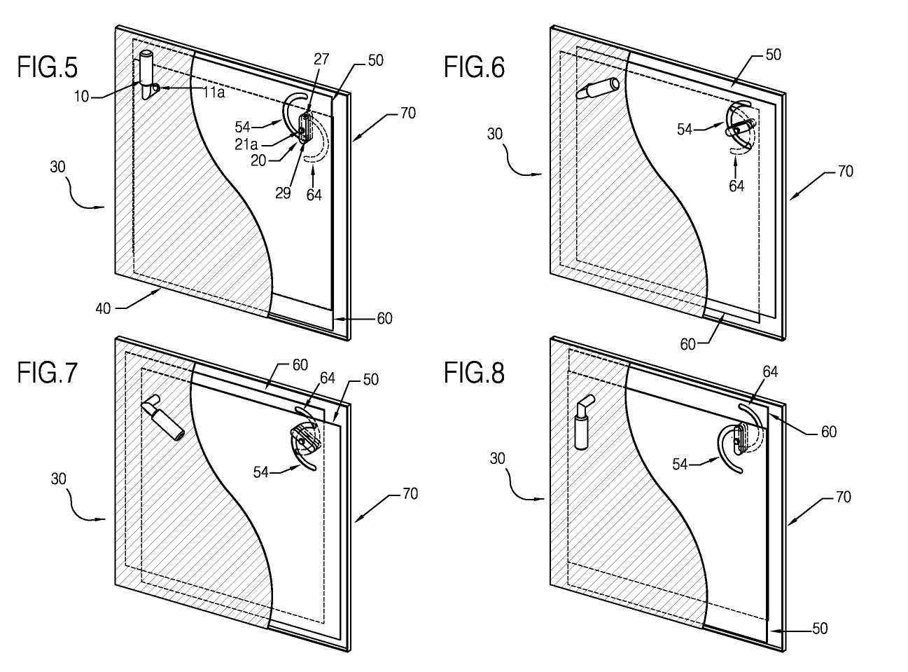

FIGS. 6 and 7 show panel assembly 30 in two intermediate positions whereby the relative locations of movable panels 50 and 60 are translated relative to their location in FIG. 5. Clearance slots 54 and 64 allow for outer pivot pins 27 and 29 to slidably move in an unobstructed manner.

It may be seen in FIGS. 5-7 that as panel 50 is successively lowered, panel 60 is successively raised. Thus, the movement of panel 50 counterbalances the movement of panel 60, thereby ensuring that the force needed to turn handle 12 is minimized.

FIG. 8 shows panel assembly 30 in a final position where movable panel 50 is in a lower location and movable panel 60 is in an upper location.

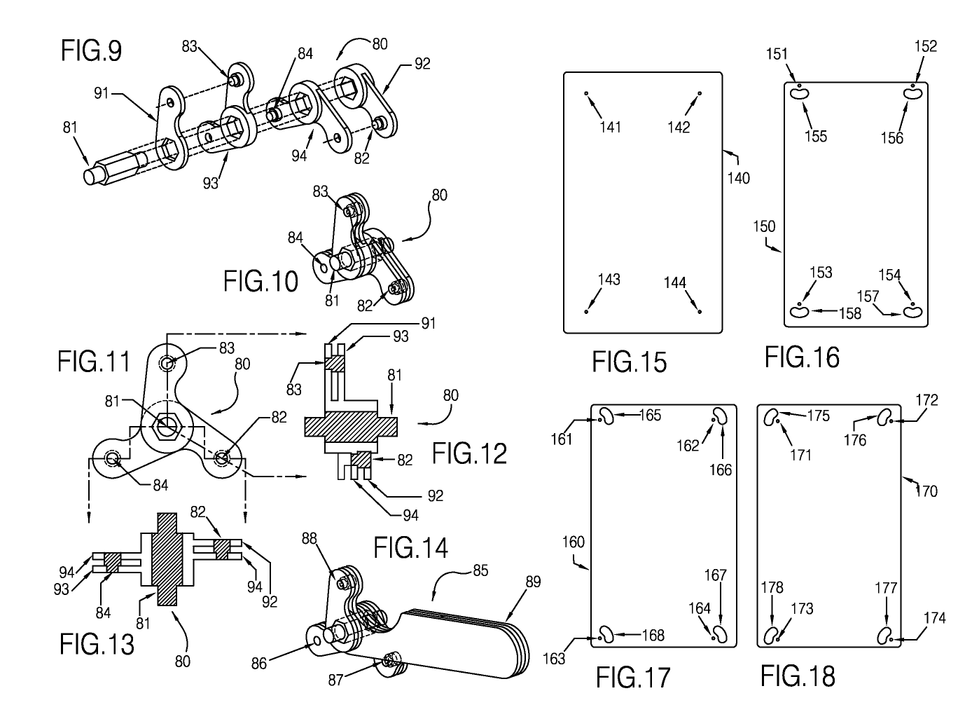

FIG. 9 shows an exploded view of a drive link 80 which is comprised of a center pivot pin 81 and four sub-links 91, 92, 93 and 94. Sub-links 91,93 share outer pivot pin 83; sub-links 93,94 share outer pivot pin 84; sub-links 94,92 share outer pivot pin 82. Center pivot pin 81 has a hexagonal profile which mates with hexagonal openings in sub-links 91, 92, 93 and 94.

FIG. 10 shows a perspective view a drive link 80 wherein center pivot pin 81 is engaged in the hexagonal openings of the four sub-links, thereby fixing them to one another.

FIG. 11 shows drive link 80 in plan view.

FIG. 12 shows a sectional view of drive link 80. Outer pivot pin 83 connects sub-links 91 and 93; outer pivot pin 82 connects sub-links 92 and 94. Sub-link and sub-link 92 lie in different planes relative to one another. Likewise, outer pivot pins 82 and 83 each lie in different planes. Center pivot pin 81 spans the depth of link 80.

FIG. 13 shows a second sectional view of drive link 80. Outer pivot pin 84 connects sub-links 93 and 94.

It may be seen that center pivot pin 81 extends from the topmost to bottommost level of link 80, whereas outer pins 82, 83 and 84 extend only between adjacent sub-links 92,94 and 94,93 and 93,91 respectively.

FIG. 14 shows a drive link 85 which is similar to drive link 80, however, it also has a handle element 89.

FIG. 15 shows a panel 140 having four pivot holes 141, 142, 143 and 144.

FIG. 16 shows a panel 150 having four pivot holes 151, 152, 153 and 154 and four slots 155, 156, 157 and 158.

FIG. 17 shows a panel 160 having four pivot holes 161, 162, 163 and 164 and four slots 165, 166, 167 and 168.

FIG. 18 shows a panel 170 having four pivot holes 171, 172, 173 and 174 and four slots 175, 176, 177 and 178.

FIGS. 19 and 20 show drive links 80a and 80b which are essentially identical to drive link 80.

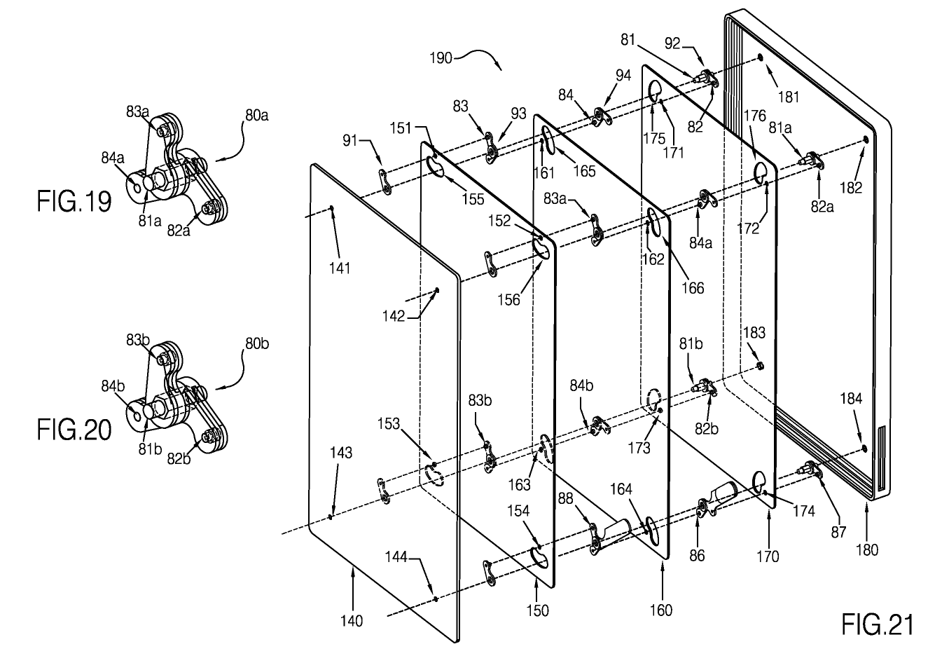

FIG. 21 shows an exploded view of panel assembly 190 which is comprised of two fixed panels 140 and 180 and three movable panels 150, 160 and 170.

Panel assembly 190 is further comprised of four drive links 80, 80a, 80b and 85 which are also shown in exploded view.

Outer pivot pin 83 of drive link 80 is aligned with pivot hole 151 of panel 150. Outer pivot pin 84 is aligned with pivot hole 161 of panel 160. Outer pivot 82 is aligned with pivot hole 171 of panel 170.

Center pivot pin 81 aligns with pivot holes 181 and 141 belonging to panels 180 and 140 respectively. Center pivot pin 81 is positioned such that it can slidably pass through slots 155, 165 and 175 allowing clearance for unobstructed movement.

Similarly, outer pivot pin 83a of drive link 80a is aligned with pivot hole 152 of panel 150. Outer pivot pin 84a is aligned with pivot hole 162 of panel 160. Outer pivot 82a is aligned with hole 172 of panel 170.

Center pivot pin 81a aligns with holes 182 and 142 belonging to panels 180 and 140 respectively. Center pivot pin 81a is positioned such that it can pass through slots 156, 166 and 176 allowing clearance for unobstructed movement.

In a similar manner, drive links 80b and 85 align with the respective holes and slots belonging to panels 140, 150, 160, 170 and 180.

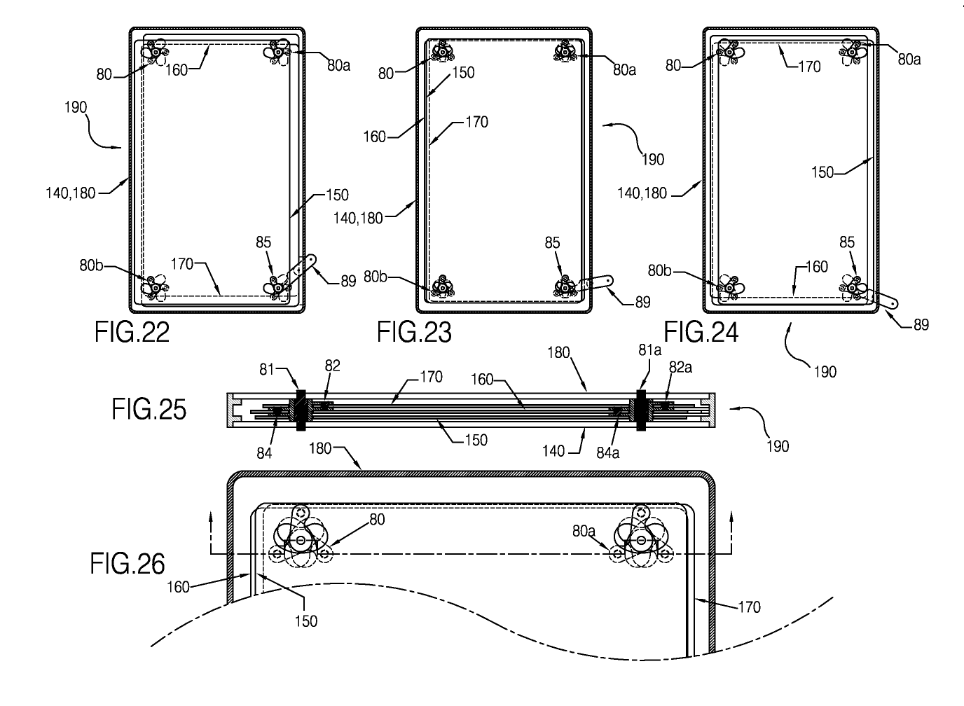

FIG. 22 shows panel assembly 190. Drive links 80, 80a, 80b and 85 have a consistent rotational position relative to fixed panels 140, 180, thereby setting a first location of movable panels 150, 160 and 170. Handle element 89 belonging to drive link 85 is in a raised position.

FIG. 23 shows panel assembly 190 in a second position wherein drive links 80, 80a, 80b and 85 have been further rotated relative to panels 140, 180, thereby providing a translated location of movable panels 150, 160 and 170 relative to FIG. 22. Handle element 89 is in an intermediate position.

FIG. 24 shows panel assembly 190 in a third position wherein drive links 80, 80a, 80b and 85 have been further rotated relative to panels 140, 180, thereby translating the locations of movable panels 150, 160 and 170. Handle element 89 is in a lower position.

It may be seen in FIGS. 22-24 that as panels 150, 160 and 170 are successively moved, the degree to which each movable panel is lowered or raised is essentially counterbalanced by the movements of the other panels. This ensures that the force needed to turn handle 89 is minimized.

FIG. 25 shows a sectional view of panel assembly 190 wherein center pivot pins 81 and 81a may be seen to span between fixed panels 140 and 180. Outer pivot pins 82 and 82a engage moveable panel 170; outer pivot pins 84 and 84a engage moveable panel 160.

FIG. 26 shows a detailed view of panel assembly 190 in its second position.

FIG. 27 shows a perspective view of panel assembly 190 in its first position where fixed panel 140 is shown in cutaway to reveal movable panels 150, 160 and 170.

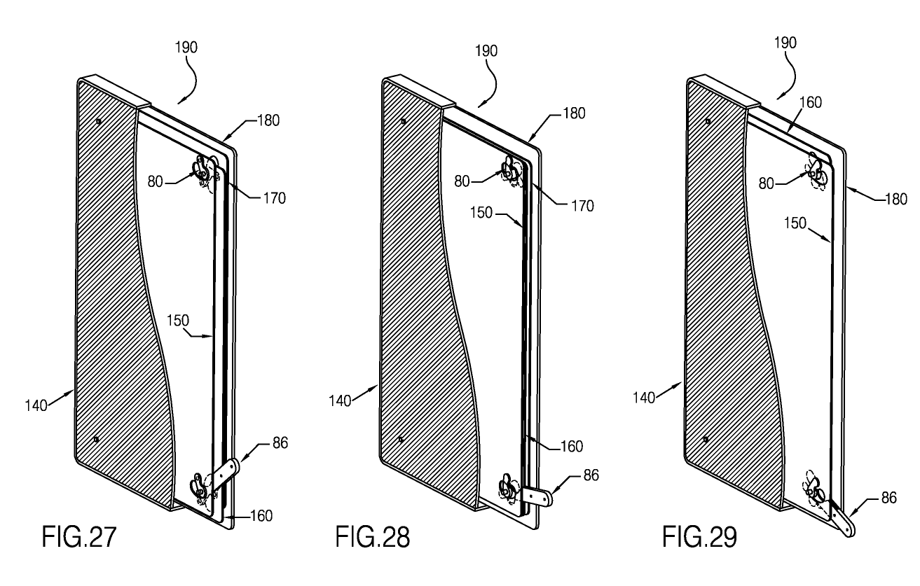

FIGS. 28 and 29 show perspective views of panel assembly 190 in its second and third position respectively.

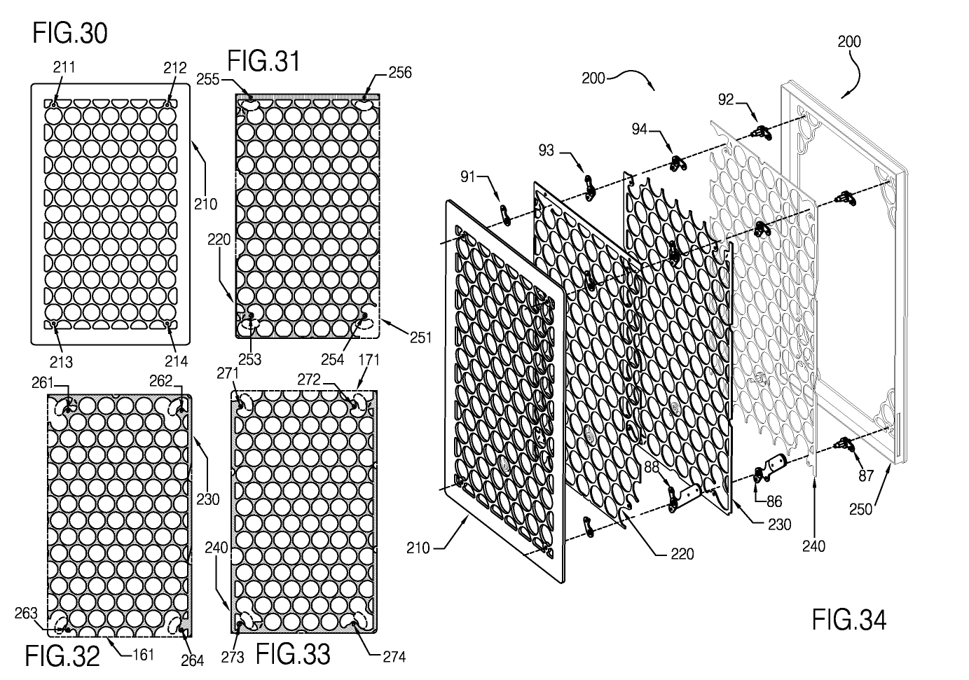

FIG. 30 shows panel 210 which is perforated with a pattern of circular holes. Panel 210 has a similar outer profile to panel 140. It has four holes 211, 212, 213 and 214 which are located in a similar position relative to its outer profile to holes 141, 142 143 and 144 belonging to panel 140.

FIG. 31 shows perforated panel 220. Also in FIG. 31 is profile 151, shown in dashed line, which corresponds to the outer profile and slots of panel 150. Panel 220 may be seen to align with profile 151. Holes 253, 254, 255 and 256 have identical locations. Holes 153, 154, 155 and 156 are in a similar position relative to profile 151. However, it may be seen that some material is removed from panel 220 relative to profile 151.

FIGS. 32 and 33 show panels 230 and 240 respectively. Panels 230 and 240 may be seen to align with profiles 161 and 172 (shown in dashed line) respectively, which in turn correspond to the outer profiles and slots of panels 160 and 170 respectively.

FIG. 34 shows an exploded view of panel assembly 200, which is comprised of two fixed panels 210 and 250, three movable panels 220, 230 and 240 as well as four drive links 80, 80a, 80b and 85. Panel assembly 200 may thus be seen to be mechanically identical to panel assembly 190. The essential difference is that the panels belonging to assembly 200 are perforated whereas the panels belonging to assembly 190 are not perforated.

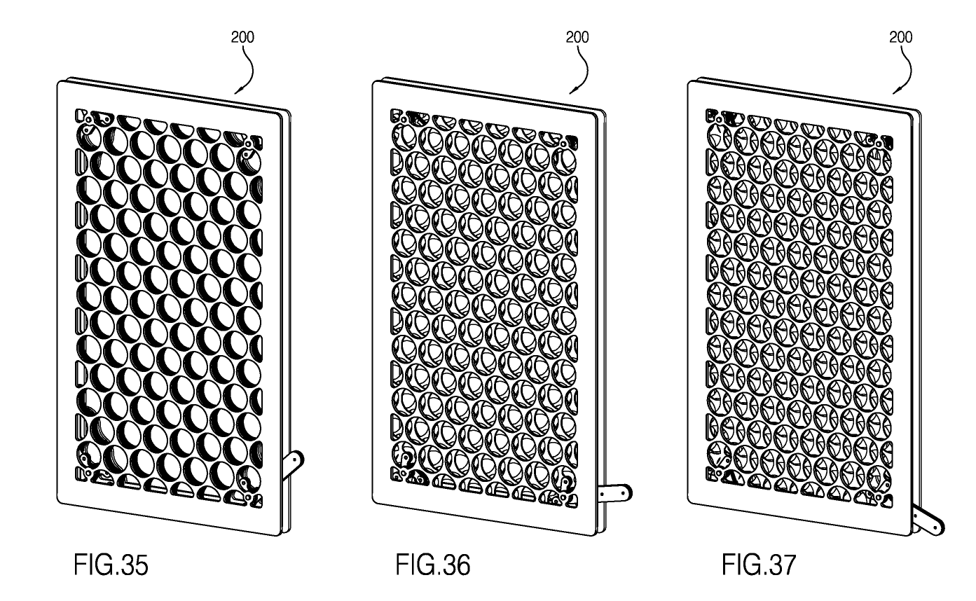

FIG. 35 shows panel assembly 200 is in a first position. Movable panels 220, 230 and 240 are located such that their perforations are aligned with the perforations of fixed panels 210 and 250. In this position, assembly 200 is in an open, non-opaque state.

FIG. 36 shows panel assembly 200 is in a second position. Movable panels 220, 230 and 240 are located such that their perforations are partially aligned with the perforations of fixed panels 210 and 250. In this position, assembly 200 is in a partially opaque state.

FIG. 37 shows panel assembly 200 is in a third position. Movable panels 220, 230 and 240 are located such that their perforations are not aligned with the perforations of fixed panels 210 and 250, thereby blocking those perforations. In this position, assembly 200 is in a fully opaque state.

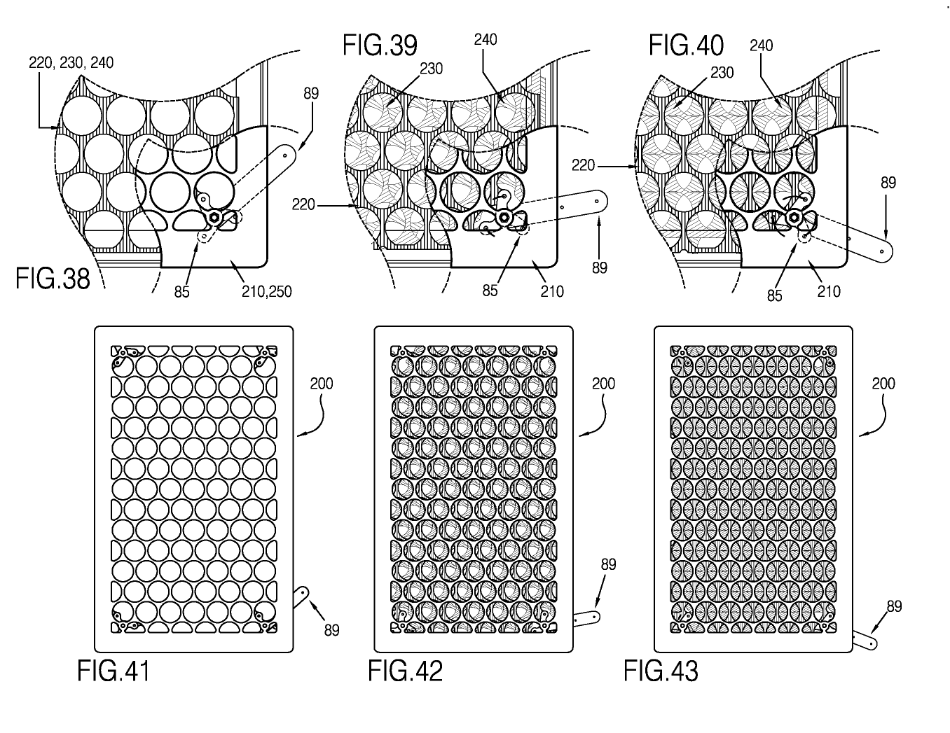

FIG. 38 shows a cutaway detail of panel assembly 200 in a first position, wherein the perforations of moveable panels 220, 230 and 240 are aligned with those of fixed panels 210, 250. Handle element 89 belonging to drive link 85 is in an upper position.

FIG. 39 shows a cutaway detail of panel assembly 200 in a second position, wherein the perforations of moveable panels 220, 230 and 240 are partially aligned with those of fixed panels 210, 250. Handle element 89 belonging to drive link 85 is in an intermediate position.

FIG. 40 shows a cutaway detail of panel assembly 200 in a third position, wherein the perforations of moveable panels 220, 230 and 240 are not aligned with those of fixed panels 210, 250. Handle element 89 belonging to drive link 85 is in a lower position.

FIGS. 41, 42 and 43 show plan views of panel assembly 200 in its first, second and third position respectively. It may be seen that panel assembly 200 may be reversibly transformed from a non-opaque, permeable state to an opaque, non-permeable state by raising and lowering handle element 89.

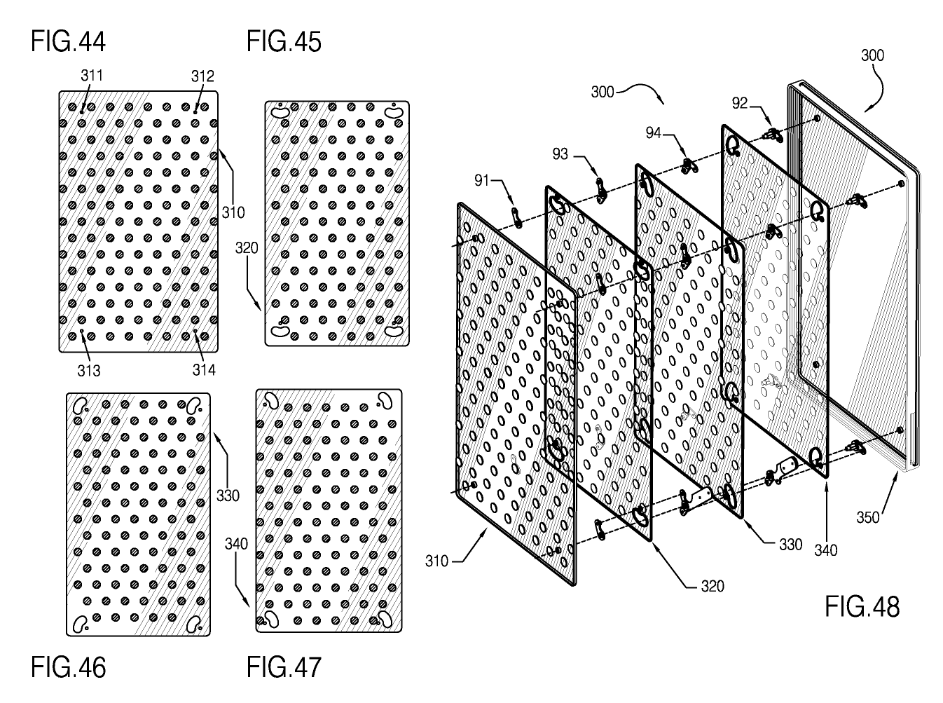

FIG. 44 shows a panel 310 having the same profile and hole locations as panel 140. Panel 310 is made of a transparent material upon which a graphic pattern of opaque circles has been applied.

FIGS. 45-47 show panels 320, 330 and 340 whose profiles, holes and slot locations are essentially identical to panels 150, 160 and 170 respectively. Panels 320, 330 and 340 are made of a transparent material upon which graphic patterns of opaque circles have been applied.

FIG. 48 shows an exploded view of panel assembly 300, which is comprised of two fixed panels 310 and 350, three movable panels 320, 330 and 340 as well as four drive links 80, 80a, 80b and 85. Panel assembly 300 may thus be seen to be mechanically identical to panel assembly 190. The essential difference is that the panels belonging to assembly 300 are transparent, and have a graphic pattern of opaque circles are applied whereas the panels belonging to assembly 190 are not transparent.

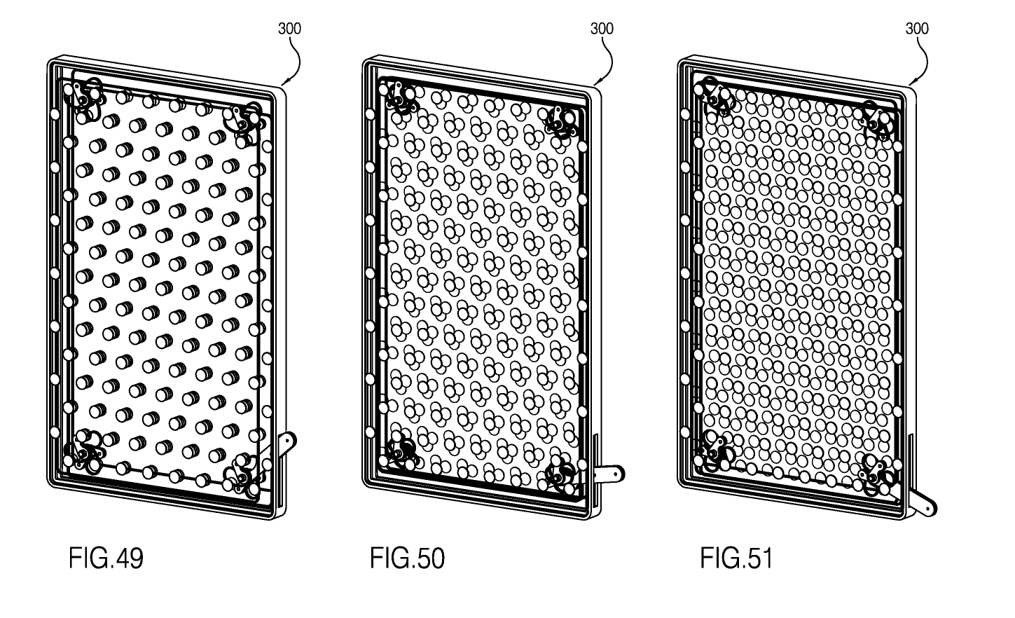

FIG. 49 shows panel assembly 300 is in a first position. Movable panels 320, 330 and 340 are located such that their circles are aligned with the circles of fixed panels 310 and 350. Due to the alignment of these circles, the majority of the surface of assembly 300 is transparent.

FIG. 50 shows panel assembly 300 is in a second position. Movable panels 320, 330 and 340 are located such that their circles are partially aligned with the circles of fixed panels 310 and 350. In this position, assembly 300 is in a partially opaque state.

FIG. 51 shows panel assembly 300 is in a third position. Movable panels 320, 330 and 340 are located such that their circles are not aligned with the circles of fixed panels 310 and 350. In this position, assembly 300 is in a largely opaque state.

FIG. 52 shows a cutaway detail of panel assembly 300 in a first position, wherein the opaque circles on moveable panels 320, 330 and 340 are aligned with those of fixed panels 310, 350, thereby creating a largely transparent surface. Handle element 89 belonging to drive link 85 is in an upper position.

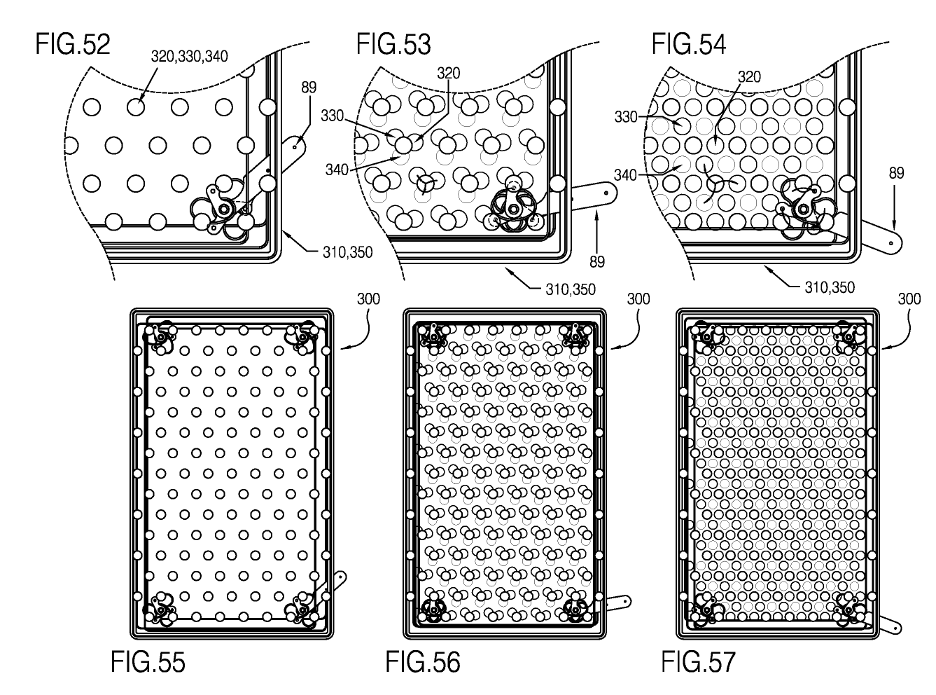

FIG. 53 shows a cutaway detail of panel assembly 300 in a second position, wherein the perforations of moveable panels 320, 330 and 340 are partially aligned with those of fixed panels 310, 350. Handle element 89 belonging to drive link 85 is in an intermediate position.

FIG. 54 shows a cutaway detail of panel assembly 300 in a third position, wherein the perforations of moveable panels 320, 330 and 340 are not aligned with those of fixed panels 310, 350, thereby creating a largely opaque surface. Handle element 89 belonging to drive link 85 is in a lower position.

FIGS. 55, 56 and 57 show plan views of panel assembly 300 in its first, second and third position respectively. It may be seen that panel assembly 300 may be reversibly transformed from a largely transparent state to a largely opaque state by raising and lowering handle element 89.

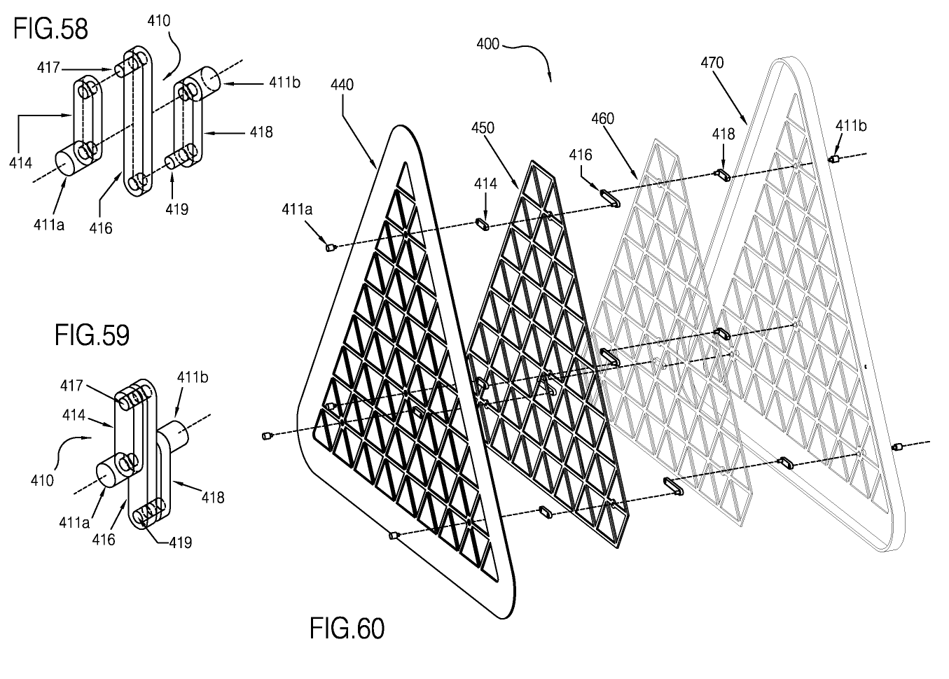

FIG. 58 shows a drive link 410 which is comprised of three sub-links 414, 416 and 418. Drive link 410 is further comprised of center pivot pins 411a, 411b and outer pivot pins 417 and 419.

FIG. 59 shows a perspective view of drive link 410. Center pivot pin 411a is co-linear, yet discontinuous, with center pivot pin 411b. Sub-links 414,416 share outer pivot pin 417. Sub-links 416,418 share outer pivot pin 419.

FIG. 60 shows an exploded view of panel assembly 400 which is comprised of fixed panels 440,470 and movable panels 450,460. Panel assembly 400 has an essentially triangular perimeter. Panels 440,450,460 and 470 have triangular perforations.

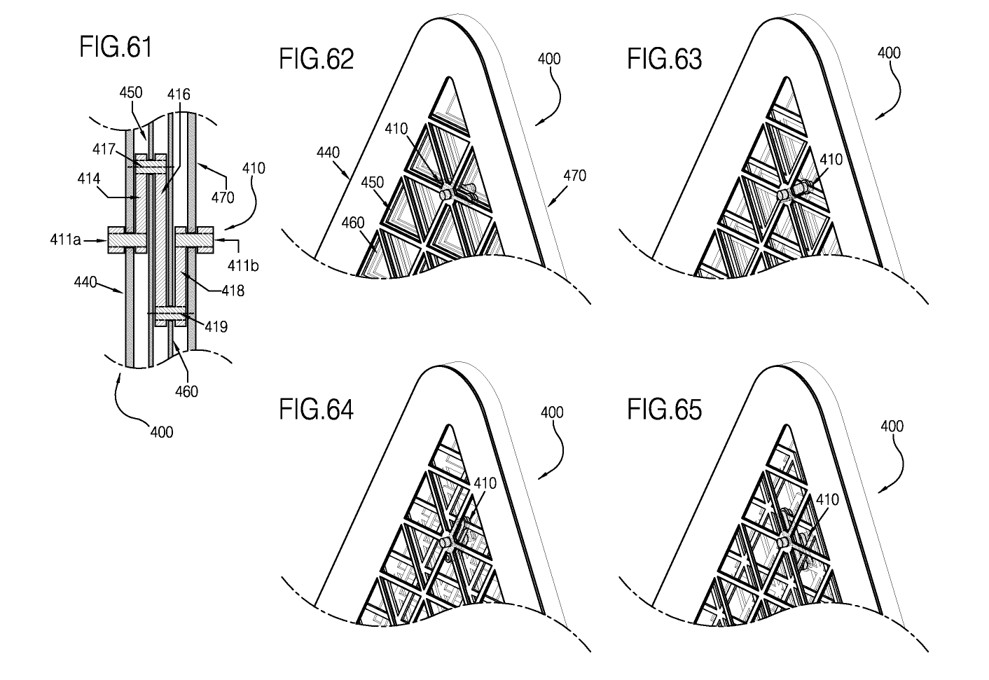

FIG. 61 shows a sectional view of assembly 400. Center pivot pin 411a engages fixed panel 440; outer pivot pin 417 engages movable panel 450; outer pivot pin 419 engages movable panel 460; center pivot pin 411b engages fixed panel 470. Sub-link and sub-link 414, 416 and 418 lie in different planes relative to each another. Likewise, outer pivot pins 417 and 419 lie in different planes.

None of the four pivot pins 411a, 417, 419 or 411b spans beyond the particular panel with which they engage. Therefore, it is unnecessary to provide clearance slots in the fixed or movable panels to allow unobstructed movement. Further, drive link 410 can be rotated a full three-hundred and sixty degrees in a continuous manner.

FIG. 62 shows a detailed perspective view of panel assembly 400 in its aligned position. Drive link 410 shown in dashed line may be seen to engage panels 440,450,460 and 470.

FIGS. 63 and 64 show panel assembly 400 in a successive partially aligned positions where drive link 410 has been successively rotated relative to its position in FIG. 62.

FIG. 65 shows panel assembly 400 in a non-aligned position.

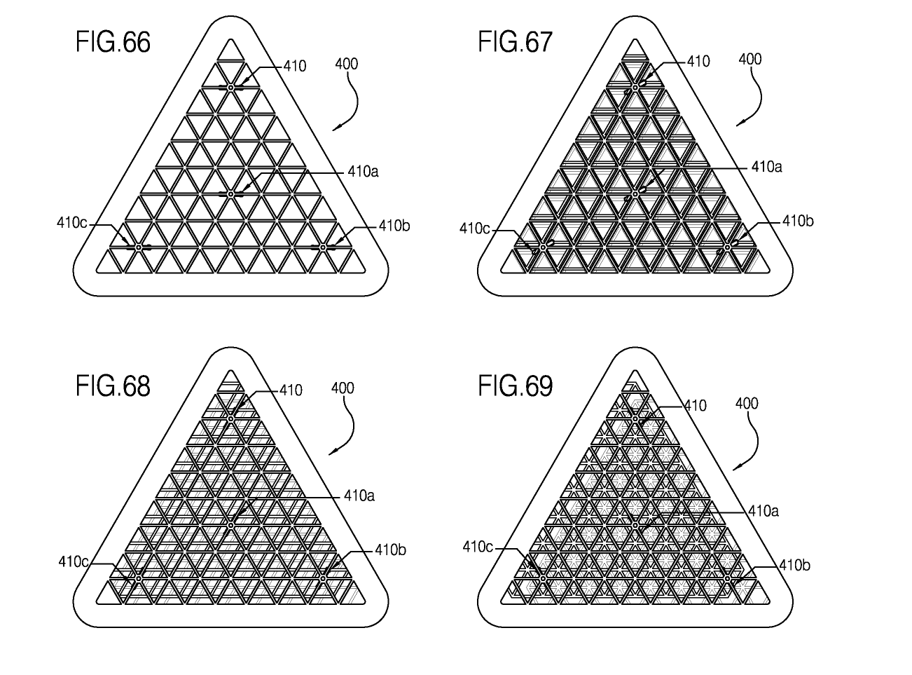

FIGS. 66 through 69 show four views of panel assembly 400 as it transforms from an aligned, largely permeable condition to a non-aligned largely non-permeable condition.

Assembly 400 has three drive links 410, 410b and 410c which are located near the perimeter of the assembly. It has one drive link 410a which is located at the center of assembly 400.

Not shown, but possible, are panel assemblies that are comprised of sheets having different acoustical properties, whether absorptive or reflective.

1. A panel assembly comprising:
a fixed panel having two spaced apart pivot holes;
a first overlying moveable panel having two spaced apart pivot holes;
a second overlying moveable panel having two spaced apart pivot holes;
two drive links with each drive link having one center pivot pin and two outer pivot pins;
wherein the center pivot pin of each said drive link pivotally engages respectively the two pivot holes of said fixed panel;
wherein one of the outer pivot pins of each said drive link pivotally engages respectively the two pivot holes of one of said moveable panels;
wherein the other of the outer pivot pins of each said drive link pivotally engages respectively the two pivot holes of the other of said moveable panels; and
wherein rotation of the two drive links causes the two moveable panels to move relative to each other and to said fixed panel between a first aligned position and a second non-aligned position.

2. An assembly according to claim 1:
wherein said panels are made of a perforated material such that in said first position, the perforations of said panels are aligned for providing a largely permeable condition, and in said second position, the perforations are not aligned for providing a largely non-permeable condition.

3. An assembly according to claim 1:
wherein said panels are made of a transparent material having a surface graphic pattern such that in said first position, the graphic pattern of the panels are aligned providing a largely transparent condition, and in said second position, the graphic patterns are not aligned for providing a largely opaque condition.

4. An assembly according to claim 1:
wherein said first moveable panel has a pair of slots in which the other of said outer pivot pins respectively are slidably received; and
wherein said second moveable panel has a pair of slots in which said one of the outer pivot pins respectively are slidably received.

5. An assembly according to claim 1, further including a handle, the turning of which causes rotation of the two drive links.

6. An assembly according to claim 1, further including a motor, the activation of which causes the rotation of the two drive links.

7. An assembly according to claim 1:
wherein one or more drive links are capable of continuous unobstructed rotation.

8. An assembly according to claim 1:
wherein the panels have a shape selected from the group consisting of rectangular and non-rectangular polygons.

9. An assembly according to claim 1:
wherein at least one of the drive links is comprised of at least two sub-links, wherein each of said sub-links connects between the center pivot pin and one of the two outer pivot pins.

10. An assembly according to claim 9:
wherein each sub-link lies in a different plane.

11. An assembly according to claim 10:
wherein one of said drive links has a depth such that the outer pivot pins span said depth.

12. An assembly according to claim 10:
wherein one of said drive links has a depth such that the center pivot pins span said depth.

13. An assembly according to claim 10:
wherein for at least one of the drive links, the center pivot pin is comprised of two or more co-linear, yet discontinuous, pivot pins.

14. An assembly according to claim 10:
wherein each outer pivot pin lies in a different plane.

15. An assembly according to claim 1:
wherein the upward movement of one movable panel is counterbalanced by the downward movement of a second movable panel.
